(19) United States
(12) Patent Application Publication
(10) Pub. No.: US 2014/0040532 A1
(43) Pub. Date: Feb. 6, 2014

(54) STACKED MEMORY DEVICE WITH HELPER PROCESSOR

(71) Applicants: Yasuko Watanabe, Kirkland, WA (US); Gabriel H. Loh, Bellevue, WA (US); James M. O'Connor, Austin, TX (US); Michael Ignatowski, Austin, TX (US); Nuwan S. Jayasena, Sunnyvale, CA (US)

(72) Inventors: Yasuko Watanabe, Kirkland, WA (US); Gabriel H. Loh, Bellevue, WA (US); James M. O'Connor, Austin, TX (US); Michael Ignatowski, Austin, TX (US); Nuwan S. Jayasena, Sunnyvale, CA (US)

(73) Assignee: ADVANCED MICRO DEVICES, INC., Sunnyvale, CA (US)

(21) Appl. No.: 13/567,958

(22) Filed: Aug. 6, 2012

(51) Int. Cl. G06F 12/00

(52) U.S. Cl. 711/103; 711/147; 711/E12.008

(57) ABSTRACT

A processing system comprises one or more processor devices and other system components coupled to a stacked memory device having a set of stacked memory layers and a set of one or more logic layers. The set of logic layers implements a helper processor that executes instructions to perform tasks in response to a task request from the processor devices or otherwise on behalf of the other processor devices. The set of logic layers also includes a memory interface coupled to memory cell circuitry implemented in the set of stacked memory layers and coupleable to the processor devices. The memory interface operates to perform memory accesses for the processor devices and for the helper processor. By virtue of the helper processor's tight integration with the stacked memory layers, the helper processor may perform certain memory-intensive operations more efficiently than could be performed by the external processor devices.

### CROSS-REFERENCE TO RELATED APPLICATIONS

The present application is related to U.S. patent application Ser. No. ______ (Docket No. 1458-110209), filed on even date herewith and entitled “Stacked Memory Device with Metadata Management,” the entirety of which is incorporated by reference herein.

### BACKGROUND

1. Field of the Disclosure

The present disclosure generally relates to memory devices, and more particularly, to stacked memory devices.

2. Description of the Related Art

Memory bandwidth and latency are significant performance bottlenecks in many processing systems. These performance factors may be improved to a degree through the use of conventional stacked, or three-dimensional (3D), memory, which provides increased bandwidth and reduced intra-device latency through the use of through-silicon vias (TSVs) to interconnect multiple stacked layers of memory. However, system memory and other large-scale memory typically are implemented as separate from the other components of the system. A system implementing 3D stacked memory therefore can continue to be bandwidth-limited due to the bandwidth of the interconnect connecting the 3D stacked memory to the other components and latency-limited due to the propagation delay of the signaling traversing the relatively-long interconnect and the handshaking process needed to conduct such signaling. The inter-device bandwidth and inter-device latency have a particular impact on processing efficiency and power consumption of the system when a performed task requires multiple accesses to the 3D stacked memory as each access requires a back-and-forth communication between the 3D stacked memory and thus the inter-device bandwidth and latency penalties are incurred twice for each access.

### BRIEF DESCRIPTION OF THE DRAWINGS

The present disclosure may be better understood, and its numerous features and advantages made apparent to those skilled in the art by referencing the accompanying drawings.

FIG. 1 is a diagram illustrating an exploded, perspective view of a processing system employing a stacked memory device with an integrated helper processor in a vertical-stack configuration in accordance with at least one embodiment of the present disclosure.

FIG. 2 is a diagram illustrating a cross-section view of an alternative implementation of the processing system of FIG. 1 in a side-split configuration in accordance with at least one embodiment of the present disclosure.

FIG. 3 is a block diagram illustrating the processing system of FIG. 1 in greater detail in accordance with at least one embodiment of the present disclosure.

FIG. 4 is a diagram illustrating an example method of operation of the stacked memory device of the processing system of FIG. 1 in accordance with at least one embodiment of the present disclosure.

FIG. 5 is a diagram illustrating an example operation of the integrated helper processor of the stacked memory device for performing a task involving a data structure stored at the stacked memory device in accordance with at least one embodiment of the present disclosure.

FIG. 6 is a diagram illustrating an example operation of the integrated helper processor of the stacked memory device for performing an interrupt handling routine in accordance with at least one embodiment of the present disclosure.

FIG. 7 is a diagram illustrating an example operation of the integrated helper processor of the stacked memory device for executing a helper thread in accordance with at least one embodiment of the present disclosure.

FIG. 8 is a diagram illustrating an example operation of the integrated helper processor of the stacked memory device for providing computed values in accordance with at least one embodiment of the present disclosure.

FIG. 9 is a flow diagram illustrating a method for designing and fabricating an integrated circuit (IC) device implementing a stacked memory and an integrated helper processor in accordance with at least one embodiment of the present disclosure.

The use of the same reference symbols in different drawings indicates similar or identical items.

### DETAILED DESCRIPTION OF PREFERRED EMBODIMENTS

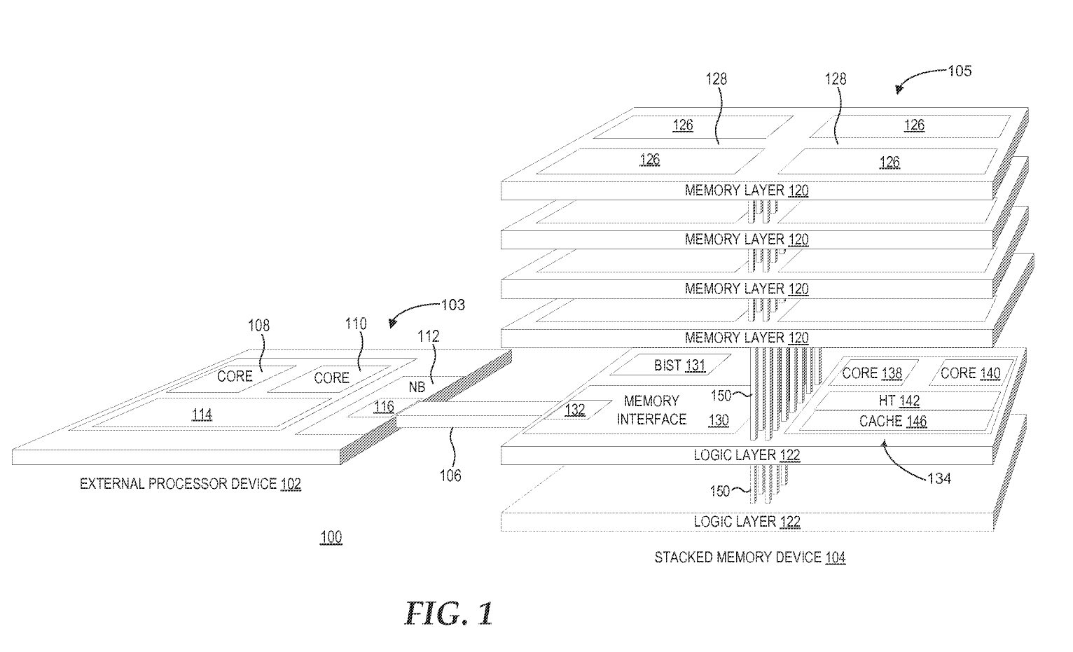

FIGS. 1-9 illustrate example techniques for improved processing efficiency and decreased power consumption using a stacked memory device implementing an integrated helper processor to offload processing tasks from one or more main processor devices. The stacked memory device includes a set of stacked memory layers and a set of one or more logic layers, wherein at least one of the one or more logic layers implements the helper processor and a memory interface. The helper processor comprises one or more processor cores that execute instructions representative a thread or other task to be performed on behalf of one or more main processing devices. The memory interface is coupled to the memory cell circuitry of the set of stacked memory layers and is coupleable to one or more processor devices external to the stacked memory device. The memory interface operates to perform memory accesses in response to memory access requests from both the helper processor and the one or more external processor devices. In a typical operation, a main processor device or other system component signals the helper processor to perform a task. In response, the helper processor fetches and executes a corresponding set of instructions to perform and complete the task. Due to the helper processor's tight integration with the memory layers, the helper processor can access data stored in the memory layers with higher bandwidth and lower latency and power consumption compared to the main processor device. Moreover, the offloading of these tasks to the helper processor permits the main processor devices to perform other tasks, thereby increasing the overall processing throughput of the system.

FIG. 1 illustrates a processing system 100 in accordance with at least one embodiment of the present disclosure. The processing system 100 can comprise any of a variety of computing systems, including a notebook or tablet computer, a desktop computer, a server, a network router, switch, or hub, a computing-enabled cellular phone, a personal digital assistant, and the like.

In the depicted example, the processing system 100 includes a processor device 102 and a stacked memory device 104 coupled via an inter-processor interconnect 106. The processing system 100 also can include a variety of other components not illustrated in FIG. 1, such as one or more display components, storage devices, input devices (e.g., a mouse or keyboard), and the like. While the processing system 100 can include multiple processor devices 102 coupled to the stacked memory device 104 via the memory bus, an example implementation with a single processor device 102 is described herein for ease of illustration. The processor device 102 is implemented as an integrated circuit (IC) package 103 and the stacked memory device 104 is implemented as an IC package 105 separate from the IC package 103 implementing the processor device 102. Accordingly, the processor device 102 is external with reference to the stacked memory device 104 and thus is referred to herein as “external processor device 102”.

The external processor device 102 comprises one or more processor cores, such as processor cores 108 and 110, a northbridge 112, and peripheral components 114. The processor cores 108 and 110 can include any of a variety of processor cores and combinations thereof, such as a central processing unit (CPU) core to execute instructions compatible with, or compiled from, one or both of an x86 or Advanced RISC Machine (ARM) instruction set architectures (ISAs), a graphics processing unit (GPU) core to execute instructions compatible with, or compiled from, a CUDA, Open Graphics Library (OpenGL), Open Computing Library (OpenCL), or DirectX application programmer interface (API). The peripheral components 114 can include, for example, an integrated southbridge or input/output controller, one or more level 3 (L3) caches, and the like. The northbridge 112 includes, or is associated with, a memory controller interface 116 comprising a physical interface (PHY) connected to the conductors of the inter-processor interconnect 106.

The inter-processor interconnect 106 can be implemented in accordance with any of a variety of conventional interconnect or bus architectures, such as a Peripheral Component Interconnect-Express (PCI-E) architecture, a HyperTransport architecture, a QuickPath Interconnect (QPI) architecture, and the like. Alternatively, the inter-processor interconnect 106 can be implemented in accordance with a proprietary bus architecture. The inter-processor interconnect 106 includes a plurality of conductors coupling transmit/receive circuitry of the memory interface 116 of the external processor 102 with the transmit/receiver circuitry of the memory interface 132 of the stacked memory device 104. The conductors can include electrical conductors, such as printed circuit board (PCB) traces or cable wires, optical conductors, such as optical fiber, or a combination thereof.

The stacked memory device 104 may implement any of a variety of memory cell architectures, including, but not limited to, volatile memory architectures such as dynamic random access memory (DRAM) and static random access memory (SRAM), or non-volatile memory architectures, such as read-only memory (ROM), flash memory, ferroelectric RAM (F-RAM), magnetoresistive RAM, and the like. For ease of illustration, the example implementations of the stacked memory device 104 are described herein in the example, non-limiting context of a DRAM architecture.

As illustrated by the exploded perspective view, the stacked memory device 104 comprises a set of stacked memory layers 120 and a set of one or more logic layers 122. Each memory layer 120 comprises memory cell circuitry 126 implementing bitcells in accordance with the memory architecture of the stacked memory device 104 and the peripheral logic circuitry 128 implements the logic and other circuitry to support access and maintenance of the bitcells in accordance with this memory architecture. To illustrate, DRAM typically is composed of a number of ranks, each rank comprising a plurality of banks, and each bank comprising a matrix of bitcells set out in rows and columns. Accordingly, in one embodiment, each memory layer 120 may implement one rank (and thus the banks of bitcells for the corresponding rank). In another embodiment, the DRAM ranks each may be implemented across multiple memory layers 120. For example, the stacked memory device 104 may implement four ranks, each rank implemented at a corresponding quadrant of each of the memory layers 120. In either implementation, to support the access and maintenance of the DRAM bit cells, the peripheral logic circuitry 128 may include, for example, line drivers, bitline/wordline precharging circuitry, refresh circuitry, row decoders, column select logic, row buffers, sense amplifiers, and the like.

The one or more logic layers 122 implement logic to facilitate access to the memory of the stacked memory device 102. This logic includes, for example, a memory interface 130, built-in self test (BIST) logic 131, and the like. The memory interface 130 can include, for example, receivers and line drivers, memory request buffers, scheduling logic, row/column decode logic, refresh logic, data-in and data-out buffers, clock generators, and the like. Although the illustrated embodiment depicts a memory controller 116 implemented at the external processor device 102, in other embodiments, a memory controller instead may be implemented at the memory interface 130. The memory interface 130 further comprises a bus interface 132 comprising a PHY coupleable to the conductors of the inter-processor interconnect 106, and thus coupleable to the external processor device 102.

In addition to implementing logic to facilitate access to the memory implemented by the memory layers 120, one or more logic layers 122 implement a helper processor 134 to execute tasks for the benefit of the external processor device 102 or other external component of the processing system 102. The helper processor 134 is coupled to the memory interface 130 and comprises one or more processor cores, such as processor cores 138 and 140, an intra-processor interconnect 142, such as a HyperTransport interconnect, one or more levels of cache 146, and the like. Although an example dual-core implementation is shown, the helper processor 134 alternatively may implement a single processor core, or more than two processor cores. As with the processor cores 108 and 110 of the external processor device 102, the processor cores 138 and 140 can include, for example, one or more of a CPU core to execute instructions compliant with, or compiled for, x86 or ARM ISAs, a GPU core to execute instructions compliant with, or compiled for, a CUDA, OpenGL, OpenCL, or DirectX APIs, a DSP to execute DSP-related instructions, and the like (but the cores 138 and/or 140 need not be the same types of cores as those cores 108 and/or 110).

In the illustrated example, the helper processor 134 and the memory interface 130 are implemented on the same logic layer 122. In other embodiments, the memory interface 130 and the helper processor 134 may be implemented on different logic layers. For example, the memory interface 130 may be implemented at one logic layer 122 and the helper processor 134 may be implemented at another logic layer 122. In yet another embodiment, one or both of the memory interface 130 and the helper processor 134 may be implemented across multiple logic layers. To illustrate, the memory interface 130 and the processor cores 138 and 140 and the intra-processor interconnect 142 may be implemented at one logic layer 122 and the cache 146 and other associated circuitry of the helper processor 134 may be implemented at another logic layer 122.

In the depicted implementation of FIG. 1, the stacked memory device 104 is implemented in a vertical stacking arrangement whereby power and signaling are transmitted between the logic layers 122 and the memory layers 120 using dense through silicon vias (TSVs) 150 or other vertical interconnects. Although FIG. 1 depicts the TSVs 150 in a set of centralized rows, the TSVs 150 instead may be more dispersed across the floorplans of the layers. Note that FIG. 1 provides an exploded-view representation of the layers 120 and 122 to permit illustration of the TSVs 150 and the components of the layers 120 and 122. In implementation, each of the layers overlies and is in contact with the preceding layer. In one embodiment, the helper processor 134 accesses with the memory implemented at the memory layers 120 directly via the TSVs 150 (that is, the helper processor 134 implements its own memory controller). In another embodiment, the memory interface 130 control access to the TSVs 150 and thus the helper processor 134 accesses the memory layers 120 through the memory interface 130.

The stacked memory device 104 may be fabricated using any of a variety of 3D integrated circuit fabrication processes. In one approach, the layers 120 and 122 each are implemented as a separate substrate (e.g., bulk silicon) with active devices and one or more metal routing layers formed at an active surface (that is, each layer comprises a separate die or “chip”). This approach can include a wafer-on-wafer process whereby a wafer comprising a matrix of dice is fabricated and thinned, and TSVs are etched through the bulk silicon. Multiple wafers are then stacked to achieve the illustrated layer configuration (e.g., a stack of four wafers comprising memory circuitry dies for the four memory layers 120 and a wafer comprising the logic die for the logic layer 122), aligned, and then joined via thermocompression. The resulting stacked wafer set is singulated to separate the individual 3D IC devices, which are then packaged. In a die-on-die process, the wafer implementing each corresponding layer is first singulated, and then the dies are separately stacked and joined to fabricate the 3D IC devices. In a die-on-wafer approach, wafers for one or more layers are singulated to generate the dice for one or more layers, and these dice are then aligned and bonded to the corresponding die areas of another wafer, which is then singulated to produce the individual 3D IC devices. One benefit of fabricating the layers 120 and 122 as dice on separate wafers is that a different fabrication process can be used to fabricate the logic layers 122 than that used to fabricate the memory layers 120. Thus, a fabrication process that provides improved performance and lower power consumption may be used to fabricate the logic layers 122 (and thus provide faster and lower-power interface logic and circuitry for the helper processor 134), whereas a fabrication process that provides improved cell density and improved leakage control may be used to fabricate the memory layers 120 (and thus provide more dense, lower-leakage bitcells for the stacked memory).

In another approach, the layers 120 and 122 are fabricated using a monolithic 3D fabrication process whereby a single substrate is used an each layer is formed on a preceding layer using a layer transfer process, such as an ion-cut process. The stacked memory device 104 also may be fabricated using a combination of techniques. For example, the logic layers 120 may be fabricated using a monolithic 3D technique, the memory layers may be fabricated using a die-on-die or wafer-on-wafer technique, or vice versa, and the resulting logic layer stack and memory layer stack then may be bonded to form the 3D IC device for the stacked memory device 104.

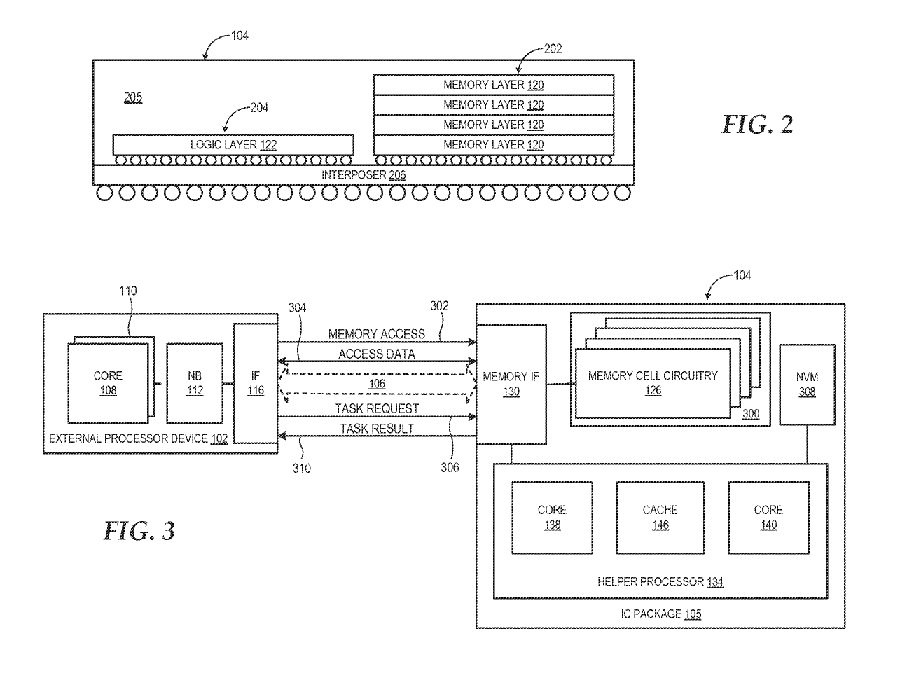

FIG. 2 illustrates a cross-section view of an alternative implementation of the stacked memory device 104 in accordance with another embodiment of the present disclosure. Rather than implement a vertical stack implementation as shown in FIG. 1 whereby the one or more logic layers 122 are vertically aligned with the memory layers 120, the stacked memory device 104 instead may implement the side-split arrangement of FIG. 2 whereby the stacked memory layers 120 are implemented as an IC device 202 and the one or more logic layers 122 are implemented as a separate IC device 204, and the IC devices 202 and 204 (and thus the logic layers 122 and the memory layers 120) are connected via a interposer 206. The interposer can comprise, for example, one or more levels of silicon interposers, a printed circuit board (PCB), or a combination thereof. Although FIG. 2 illustrates the stacked memory layers 120 together implemented as a single IC device 202, the stacked memory layers 120 instead may be implemented as multiple IC devices 202, with each IC device 202 comprising one or more memory layers 120. Likewise, the logic layers 122 may be implemented as a single IC device 204 or as multiple IC devices 204. The one or more IC devices 202, the one or more IC devices 204, and the unifying substrate 206 are packaged as an IC package 205 representing the stacked memory device 104.

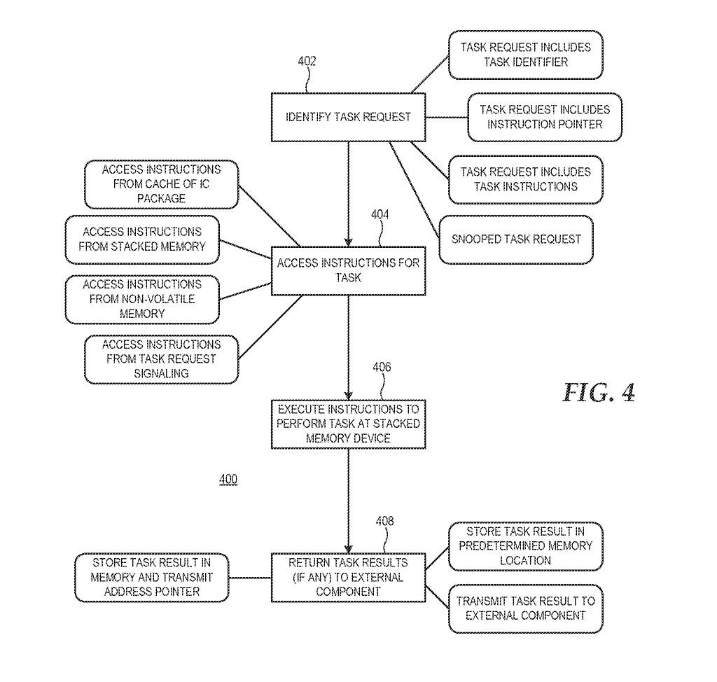

FIG. 3 illustrates the processing system 100 in block diagram form and FIG. 4 illustrates an example method of operation of the processing system 100 in accordance with at least one embodiment of the present disclosure. As noted above, the processing system 100 includes one or more external processor devices 102 and the stacked memory device 104 coupled via a inter-processor interconnect 106, whereby the stacked memory device 104 implements a stacked memory 300 represented by multiple stacked layers of memory cell circuitry 126 and implements a helper processor 134 to execute tasks on behalf of the external processor device 102 or other system component (e.g., a peripheral device). The stacked memory device 104 further includes the memory interface 130 to perform memory accesses in response to memory access requests from both the external processor device 102 and the helper processor 134.

In operation, the stacked memory device 104 can function both as a conventional system memory for storing data on behalf of other system components and as a processing resource for offloading tasks from the external processor devices 102 of the processing system 100. In a conventional memory access operation, the external processor device 102 (or other system component) issues a memory access request 302 by manipulating the PHY of its memory interface 116 to transmit address signaling and, if the requested memory access is a write access, data signaling via the inter-processor interconnect 106 to the stacked memory device 104. The PHY of the memory interface 130 receives the signaling, buffers the memory access request represented by the signaling, and then accesses the memory cell circuitry 126 to fulfill the requested memory access. In the event that the memory access request 302 is a write access, the memory interface 130 stores the signaled data to the location of the memory 300 indicated by the signaled address. In the event that the memory access request 302 is a read request, the memory interface 130 accesses the requested data from the location of the memory 300 corresponding to the signaled address and manipulates the PHY of the memory interface 130 to transmit signaling representative of the accessed data 304 to the external processor device 102 via the inter-processor interconnect 106.

Method 400 of FIG. 4 illustrates, in the example context of the block diagram of FIG. 3, an example operation of the stacked memory device 104 as a processing resource that offloads tasks from the external processor device 102 or other system component. The method 400 initiates at block 402, whereupon the helper processor 134 receives or otherwise identifies a task request 306 for a helper task to be performed. In one embodiment, this task request 306 is an explicit task request signaled by an external component. For example, the external processor device 102 may need to have an operation performed in which multiple accesses to a data structure stored in the memory are to be performed. Due to the tight integration between the helper processor 134 and the memory cell circuitry 126, the helper processor 134 is well suited for this operation and thus the external processor device 102 signals the task request 306 to assign the operation to the helper processor 134.

In another embodiment, the task request 306 is an implicit task request whereby the helper processor 134 snoops the inter-processor interconnect 106 or another external interface to which the stacked memory device 104 is connected to opportunistically identify tasks which the helper processor 134 can intercept and perform on behalf of another system component. For example, the helper processor 134 may be configured to provide the interrupt handling tasks for the processing system 100 such that when the helper processor 134 detects an exception event, the helper processor 134 loads and executes the corresponding exception handling routine. As another example, the helper processor 134 may snoop the inter-processor interconnect 106 or another interconnect to detect a request from one system component for a computed value from another system component. In this situation, the helper processor 134 may cache previously-transmitted computed values and thus provide the computed value if cached, or the helper processor 134 instead may load the instructions representing the calculation that results in the computed value and perform the computation itself and return the requested computed value. Further, the helper processor 134 can operate on cacheable or uncacheable data. To operate on cacheable data, the helper processor 134 typically would initiate snoops on the inter-processor interconnect 106 for all referenced data. As part of the snooping process, the helper processor 134 may implement a snooping filter in the memory stack to improve performance and power efficiency. In yet another embodiment, the helper tasks to be performed by the helper processor 134 are programmed or set at start-up or initialization of the processing system 100, in which case the task request 306 may represent this programming or initialization process. To illustrate, the helper processor 134 may be configured during initialization to perform virus scan tasks or defragmentation tasks on behalf of the processing system 100.

In one embodiment, the helper processor 134 is visible to one or more operating systems or hypervisors executed at the external processor 102 and thus tasks may be assigned to the helper processor 134 at the hypervisor, OS, or application level. In this configuration, the program of instructions representing the tasks to be performed by the helper processor 134 may be loaded into the memory 300 at the direction of the hypervisor, OS, or application. These instructions may be loaded at system-initialization or during initialization of an application, or the task request 306 itself may include a representation of the instructions to be executed (that is, the instructions to be executed for a task may be transmitted as part of the task request). Alternatively, the stacked memory device 104 may implement a fixed set of tasks and thus include a non-volatile memory 308 that stores some or all of the instructions representing the set of tasks to be performed. In this case, the set of tasks may be programmed or updated via a firmware update for the stacked memory device 104.

In another embodiment, the helper processor 134 is not visible to the OS or hypervisor executed at the external processor device 102. In this case, the helper processor 134 may implement a separate OS (initially stored in the non-volatile memory 308) to manage the processing resources of the stacked memory device 104. In this configuration, the external processor device 102 may implement hardware logic or a microcode set that manipulates the external processor device 102 to signal a task request 306 for a task to be offloaded, in response to which the OS at the helper processor 134 loads the corresponding program into the memory 300, or alternatively, the cache 146, for execution by one or more of the processor cores 138 and 140 of the helper processor 134. The program may be to the memory 300 from the non-volatile memory 308 or from another data storage device, such as a hard disk drive (not shown).

After identifying the task to be performed, at block 404 the helper processor 134 accesses the task instructions for the identified task for execution. In one embodiment, the task instructions are pre-stored in the cache 146 or the memory 300 during an initialization of the stacked memory device 104 or during an initialization of an OS or application. Alternatively, the task instructions may be stored in the non-volatile memory 308 and thus may be loaded from the non-volatile memory 308 to the cache 146 or an accessible portion of the memory 300. As also noted above, the task request 306 itself may include some or all of the task instructions, in which case the task instructions transmitted with the task request 306 may be stored in the cache 146 or memory 300.

At block 406, the helper processor 134 sets the program counter (PC) to the initial instruction of the task instructions, and begins execution of the task instructions to perform the requested task. The execution of the task instructions typically includes accesses to data stored in the memory 300. Due to the relatively short and relatively wide interconnect between the helper processor 134 and the memory cell circuitry 126 of the memory 300, these accesses are performed faster and with less power consumed than comparable accesses performed by the external processor device 102 to the memory 300 of the stacked memory device 104. If the task includes the reporting of results or calls for the provision of data to the requesting external component, at block 408 the helper processor 134 manipulates the memory interface 130 to signal a representation of the results or data to the requesting device as a task result 310. In one embodiment, the representation includes the results, a completion code, or data. In another embodiment, the task results may be stored in a predetermined location of the memory 300 and the requesting component may then access this predetermined location to obtain the task results. In yet another embodiment, the task results may be stored at a dynamic location of the memory 300 and the representation of the task results can include an address pointer to the dynamic location so that the requested component may then access the task results from the memory 300.

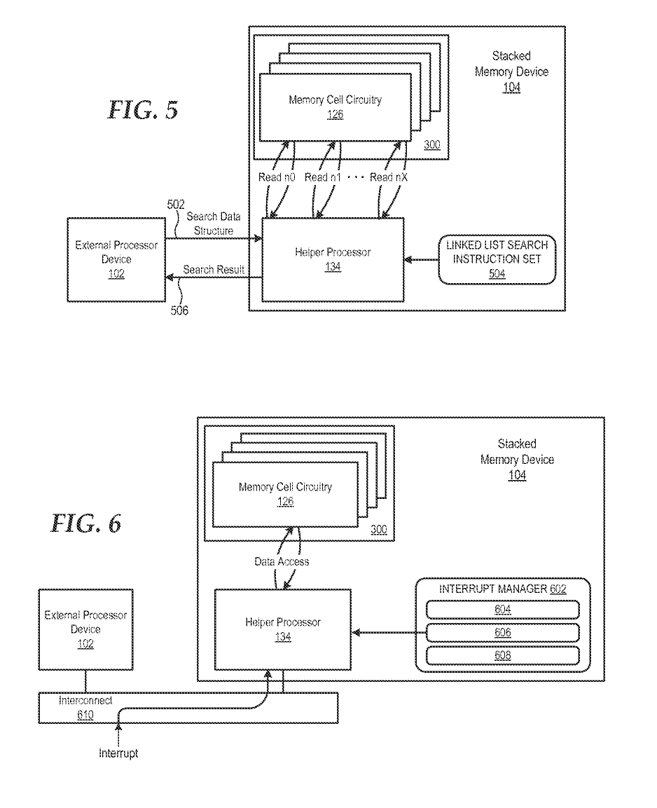

FIGS. 5-8 illustrate examples of helper tasks performed by the stacked memory device 104 in order to take advantage of the low-latency, high-bandwidth connection between the helper processor 134 and the stacked memory 300 or to otherwise offload tasks for other processing components of the processing system 100.

FIG. 5 depicts a use of the helper processor 134 to perform a data structure operation on behalf of the external processor device 102. Many computer programs use data structures for data storage. Examples of such data structures include, but are not limited to, arrays, linked lists, tables, sets, hashes, trees, graphs, matrices, and the like. Manipulation of the data stored in such data structures typically is performed using any of a variety of data structure operations, including, for example, add, insert, delete, modify, search, sort, find minimum, find maximum, and find average or other arbitrary operations, and the like. Other data-structure related operations that may be performed can include, for example, filtering, matrix operations, table joins, other database operations, etc. The operations performed by the helper processor 134 in association with one or more data structures further can include, for example, MapReduce operations (particularly in a clustered computing configuration), fast Fourier transforms (FFTs), and other high-performance computing (HPC) operations, as well as operations on graphic or audio data. Many of these data structure operations involve multiple memory accesses to complete the operation. In a conventional system, each memory access would incur several delay penalties, including as a delay penalty due to arbitration on the bus connecting the processor device to the memory in order to transmit the memory access request, a delay penalty due to the propagation delay in the transmitted request signaling, a delay penalty due to the access performed at the memory, a delay penalty due to arbitration on the bus in order to transmit the accessed data, and a delay penalty due to the propagation delay in the transmitted data signaling. The net sum of the delay penalties for the multiple sequential memory accesses can significantly impact the performance of the data structure operation.

Accordingly, to accelerate the data structure operation, the external processor device 102 can direct the helper processor 134 to perform data structure operations for data structures stored in the stacked memory 300. To illustrate, a program executed by the external device processor 102 may call for a search of a linked list to identify the node storing a particular value (the search key). Rather than having the external processor node 102 access and process each node sequentially, with the accompanying delay penalties, the external processor node 102 instead may instruct the helper processor 134 to carry out the search of the linked list by transmitting a search command 502 (one embodiment of the task request 306). In this example, the generation of the search command 502 may be specified by an instruction of the program (that is, the program is compiled so that instructions corresponding to a linked list search compile to an instruction that generates the search command 502). The search command 502 can include the instructions to implement the linked list search or may include a pointer to the linked list in the memory 300 and a task identifier or other pointer to a set of instructions 504 that manipulate the helper processor 134 to sequentially search through each node n of the linked list until the search key is found at a node or the last node is reached without finding the search key. The node at which the search key was found (or a “not found” indicator if no node contained the search key) may be returned by the helper processor 134 to the external processor device 102 as a search result 506 to signal completion of the linked list search task.

Because the helper processor 134 is integrated with the stacked memory 300, the helper processor 134 avoids the bus arbitration penalty that the external processor device 102 otherwise would encounter on each access to a corresponding node. Moreover, due to the physical proximity of the helper processor to the stacked memory 300, the helper processor 134 experiences a much smaller signal propagation delay compared to what the external processor device 102 would encounter. Accordingly, by offloading the data structure operation to the helper processor 134, the data structure operation is performed both faster and with less power consumed, while also freeing the external processor device 102 to perform other tasks in the meantime.

FIG. 6 depicts a use of the stacked memory device 104 to handle interrupt processing on behalf of the external processor device 102 of the processing system 100. In this example, the stacked memory 300 or the non-volatile memory 308 of the stacked memory device 104 may store, and the helper processor 134 may execute, a set of instructions representative of an interrupt manager 602. The interrupt manager 602 includes an interrupt filter (not shown) to filter certain interrupts, and includes or is otherwise associated with a plurality of interrupt handling routines, such as interrupt handling routines 604, 606, and 608, to process interrupts not denied by the interrupt filter.

In the illustrated example, the interrupt manager 602 manipulates the stacked memory device 104 to snoop an inter-processor interconnect 610 for a signaled interrupt, such as an OS interrupt, a system timer interrupt, or an I/O device interrupt. In response to detecting a signaled interrupt, the interrupt manager 602 applies the interrupt filter to determine whether the interrupt is to be processed by the stacked memory device 104. For example, the interrupt manager 602 may be configured to permit processing of I/O interrupts and system timer interrupts while leaving OS interrupts and other software interrupts to be handled by the external processor device 102. As another example, the interrupt manager 602 may be disabled completely while the external processor device 102 is in a non-sleep state, but when the external processor device 102 enters a sleep state, the interrupt manager 602 is enabled to handle all interrupts for the processor device 102, thereby allowing the external processor device 102 to remain in the sleep state longer, which in turn results in power savings for the processing system 100. In the event that the interrupt manager 602 is permitted to handle the interrupt, the interrupt is intercepted by the interrupt manager 602 and an interrupt handling routine is selected based on the vector of the interrupt. The selected interrupt handling routine is then loaded and executed by the helper processor 134 to process the interrupt.

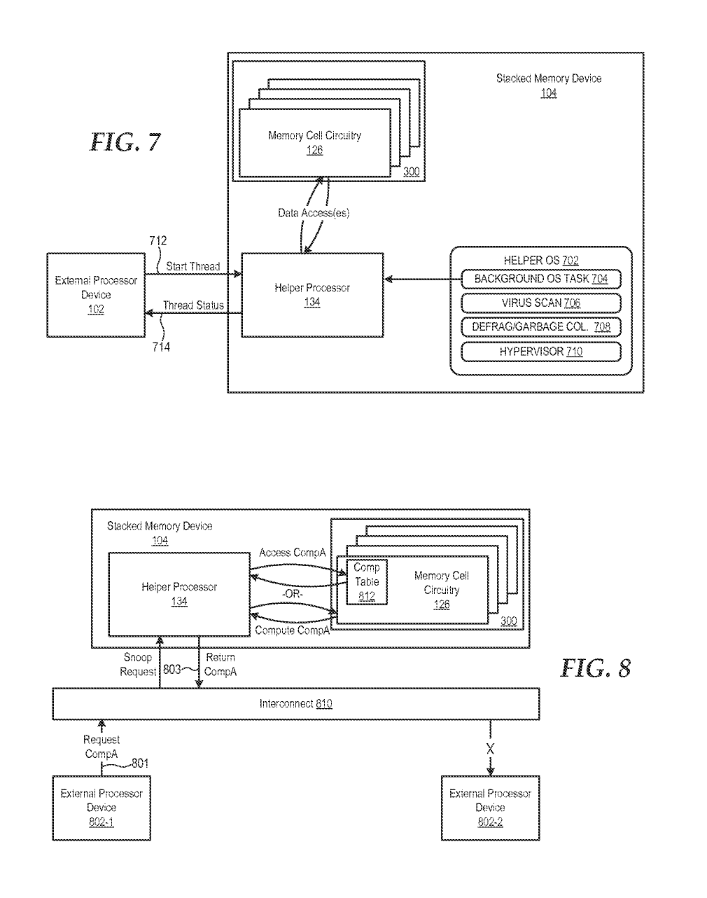

FIG. 7 illustrates an example use of the helper processor 134 for executing low-priority or background threads where performance is not a critical factor. This approach can provide better performance/energy efficiency by running the low-level thread/application on the more efficient helper processor core 134 while permitting the external processor device 102 to focus on higher-priority threads or applications, to stay in a sleep state longer, or enter a deeper sleep state.

Under this approach, the stacked memory device 104 may be pre-programmed to execute certain low-level threads. For example, the stacked memory device 104 may implement a low-level helper operation system (OS) 702 that is programmed to facilitate default execution of one or more predefined helper threads, in either a single-threaded or multithreaded manner. The helper threads can include, for example, threads 704 for performing background OS tasks (such as logging, system monitoring, scheduling, and user notification tasks), a thread 706 for performing a virus scan of the memory 300 or an external memory or other data store, a thread 708 for performing a defragmentation process or garbage collection process for the memory 300 or an external memory or other data store, or a thread 710 for implementing a hypervisor (also called a virtual machine manager (VMM)) for the processing system 100. In this example, the helper OS 702 is initialized in response to a power-on reset or other reset event and, upon completion of initialization, loads one or more of the predefined helper threads for execution. In an alternative embodiment, the external processor 102 or other external processing component may request execution of a helper task by signaling a start thread request 712. A thread status 714 may be periodically reported by the helper processor 134.

FIG. 8 illustrates an example use of the stacked memory device 104 for supporting redundant execution of functions or other calculations to reduce communication between external processor devices. In a conventional system, when one processor device requires a value computed by another processor device, the requesting processor device would be required to transmit the request for the computed value to system memory, which would then have to forward the request to the other processor device. The other processor device would then have to respond by transmitting the requested computed value to the system memory, which then would forward the computed value back to the requesting processor device. This approach interferes with the other processor device and requires a number of data hops, thereby tying up the inter-processor interconnect connecting the system memory and the processor devices.

To reduce the impact of request for computed values, the helper processor 134 can snoop an inter-processor interconnect 810 connecting external processor devices for transmissions of computed values. Detected computed values may be stored to a computed value table 812 maintained in the memory 300. Alternatively, the detected computed values may be stored in state registers or other registers at the helper processor 134. In this example, when the helper processor snoops a request 801 for a computed value CompA from the external processor device 802-1, the helper processor 134 can intercept the request 801 and access the computed value CompA from the computed value table 812. In an alternative embodiment, in addition to, or rather than, storing the computed values in the computed value table 812, the helper processor 134 instead may store the data used to compute the computed value CompA (that is, store the operands used to compute CompA) and, in response to a request for the computed value CompA, recompute the requested computed value CompA from the stored operands in accordance with the corresponding function or other computation. In either approach, the accessed computed value, or the recomputed value, CompA is then provided to the external processor device 802-1 in a response 803. In this manner, the external processor device 802-2 is not required to handle the request, thereby avoiding interfering with the external processor device 802-2 and avoiding traffic between the stacked memory device 104 and the external processor device 802-2 on the interconnect 810 that otherwise would have occurred in a conventional system.

In at least one embodiment, the apparatus and techniques described above are implemented in a system comprising one or more integrated circuit (IC) devices (also referred to as integrated circuit packages or microchips), such as the stacked memory device 104 of FIGS. 1-8. Electronic design automation (EDA) and computer aided design (CAD) software tools may be used in the design and fabrication of these IC devices. These design tools typically are represented as one or more software programs. The one or more software programs comprise code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

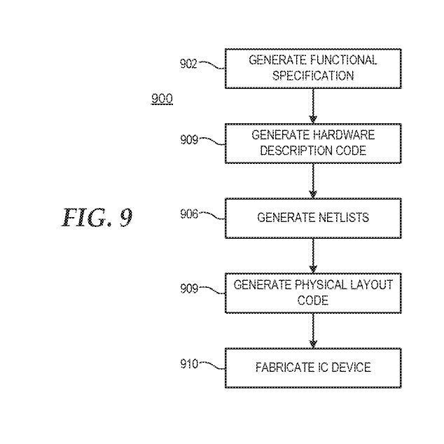

FIG. 9 is a flow diagram illustrating an example method 900 for the design and fabrication of an IC device implementing one or more aspects of the present invention in accordance with at least one embodiment of the present disclosure. As noted above, the code generated for each of the following processes is stored or otherwise embodied in computer readable storage media for access and use by the corresponding design tool or fabrication tool.

At block 902 a functional specification for the IC device is generated. The functional specification (often referred to as a micro architecture specification (MAS)) may be represented by any of a variety of programming languages or modeling languages, including C, C++, SystemC, Simulink, or MATLAB.

At block 904, the functional specification is used to generate hardware description code representative of the hardware of the IC device. In at least one embodiment, the hardware description code is represented using at least one Hardware Description Language (HDL), which comprises any of a variety of computer languages, specification languages, or modeling languages for the formal description and design of the circuits of the IC device. The generated HDL code typically represents the operation of the circuits of the IC device, the design and organization of the circuits, and tests to verify correct operation of the IC device through simulation. Examples of HDL include Analog HDL (AHDL), Verilog HDL, SystemVerilog HDL, and VHDL. For IC devices implementing synchronized digital circuits, the hardware descriptor code may include register transfer level (RTL) code to provide an abstract representation of the operations of the synchronous digital circuits. For other types of circuitry, the hardware descriptor code may include behavior-level code to provide an abstract representation of the circuitry's operation. The HDL model represented by the hardware description code typically is subjected to one or more rounds of simulation and debugging to pass design verification.

After verifying the design represented by the hardware description code, at block 906 a synthesis tool is used to synthesize the hardware description code to generate code representing or defining an initial physical implementation of the circuitry of the IC device. In one embodiment, the synthesis tool generates one or more netlists comprising circuit device instances (e.g., gates, transistors, resistors, capacitors, inductors, diodes, etc.) and the nets, or connections, between the circuit device instances. Alternatively, all or a portion of a netlist can be generated manually without the use of a synthesis tool. As with the hardware description code, the netlists may be subjected to one or more test and verification processes before a final set of one or more netlists is generated.

Alternatively, a schematic editor tool can be used to draft a schematic of circuitry of the IC device and a schematic capture tool then may be used to capture the resulting circuit diagram and to generate one or more netlists (stored on a computer readable media) representing the components and connectivity of the circuit diagram. The captured circuit diagram may then be subjected to one or more rounds of simulation for testing and verification.

At block 908, one or more EDA tools use the netlists produced at block 906 to generate code representing the physical layout of the circuitry of the IC device. This process can include, for example, a placement tool using the netlists to determine or fix the location of each element of the circuitry of the IC device. Further, a routing tool builds on the placement process to add and route the wires needed to connect the circuit elements in accordance with the netlist(s). The resulting code represents a three-dimensional model of the IC device. The code may be represented in a database file format, such as, for example, the Graphic Database System II (GDSII) format. Data in this format typically represents geometric shapes, text labels, and other information about the circuit layout in hierarchical form.

At block 910, the physical layout code (e.g., GDSII code) is provided to a manufacturing facility, which uses the physical layout code to configure or otherwise adapt fabrication tools of the manufacturing facility (e.g., through mask works) to fabricate the IC device. That is, the physical layout code may be programmed into one or more computer systems, which may then control, in whole or part, the operation of the tools of the manufacturing facility or the manufacturing operations performed therein.

In accordance with one aspect of the present disclosure, a system comprises an integrated circuit (IC) package. The IC package comprises a set of stacked memory layers comprising memory cell circuitry. The IC package also comprises a set of one or more logic layers electrically coupled to the set of stacked memory layers, the set of one or more logic layers comprising a helper processor coupled to the memory cell circuitry of the set of stacked memory layers and comprising a memory interface coupled to the helper processor and coupleable to a processor device external to the IC package, the memory interface to perform memory accesses for the external processor device and to perform memory accesses in response for the helper processor. In accordance with another aspect, a computer readable medium stores code executable to adapt at least one computer system to perform a portion of a process to fabricate at least part of the IC package.

In accordance with another aspect of the present disclosure, a method comprises providing an IC package comprising a set of stacked memory layers comprising memory cell circuitry, and comprising a set of one or more logic layers electrically coupled to the set of stacked memory layers, the set of one or more logic layers comprising a helper processor coupled to the memory cell circuitry of the set of one or more stacked memory layers and comprising a memory interface coupled to the helper processor and coupled to a processor device external to the IC package. The method further includes operating the memory interface to perform memory accesses for at least the external processor device, and accessing and executing instructions at the helper processor to perform at least one task on behalf of at least the external processor device.

In accordance with another aspect of the present disclosure, a method comprises, in response to a request from a processor device external to an IC package, executing instructions at a helper processor of the IC package, the instructions including instructions to perform one or more data accesses to a stacked memory of the IC package.

In accordance with yet another aspect of the present disclosure, a method comprises executing instructions at helper processor of an IC package to perform an operation on a data structure stored in stacked memory of the IC package in response to a request from a processor device external to the IC package.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed.

Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A system comprising:
an integrated circuit (IC) package comprising:
a set of stacked memory layers comprising memory cell circuitry; and
a set of one or more logic layers electrically coupled to the set of stacked memory layers, the set of one or more logic layers comprising a helper processor coupled to the memory cell circuitry of the set of stacked memory layers and comprising a memory interface coupled to the helper processor and coupleable to a processor device external to the IC package, the memory interface to perform memory accesses for the external processor device and to perform memory accesses for the helper processor.

2. The system of claim 1, wherein the set of one or more logic layers comprises:
a first logic layer comprising the helper processor; and
a second logic layer comprising the memory interface.

3. The system of claim 1, wherein the helper processor comprises a first processor core to execute instructions in accordance with a first instruction set architecture (ISA) and a second processor core to execute instructions in accordance with a second ISA.

4. The system of claim 3, wherein the first processor core comprises a central processing unit (CPU) core and the second processor core comprises a graphics processing unit (GPU) core.

5. The system of claim 1, wherein the helper processor is to execute instructions stored in the IC package.

6. The system of claim 5, wherein at least a portion of the instructions are stored in a non-volatile memory of the IC package.

7. The system of claim 5, wherein at least a portion of the instructions are stored in the memory cell circuitry.

8. The system of claim 5, wherein the instructions include instructions to manipulate the helper processor to perform at least one operation on a data structure stored in the memory cell circuitry and to provide for output to the external processor device a result of the at least one operation on the data structure.

9. The system of claim 5, wherein the instructions include instructions to manipulate the helper processor to execute an interrupt handling routine responsive to an interrupt.

10. The system of claim 5, wherein the instructions include instructions to manipulate the helper processor to execute at least one thread.

11. The system of claim 5, wherein the instructions include instructions to manipulate the helper processor to store at the memory cell circuitry a value representing a result of a computation performed by a first external processor device and to manipulate the helper processor to access the value from the memory cell circuitry and output the value to a second external processor device in response to a request from the second external processor device for the result of the computation from the first external processor.

12. The system of claim 5, wherein the instructions include instructions to manipulate the helper processor to recalculate a result of a computation performed by a first external processor device by accessing data for the computation from the memory cell circuitry and to manipulate the helper processor to output the result to a second external processor device in response to a request from the second external processor device for the result of the computation from the first external processor.

13. The system of claim 1, wherein the set of stacked memory layers and the set of one or more logic layers are disposed in a stacked configuration whereby the memory interface is connected to the stacked memory layers via a set of through silicon vias.

14. The system of claim 1, wherein the set of stacked memory layers and the set of one or more logic layers are disposed in a side-split arrangement whereby memory interface is connected to the stacked memory layers via an interposer.

15. The system of claim 1, further comprising:
the external processor device; and
an inter-processor interconnect coupled to the external processor device and coupled to the memory interface.

16. A computer readable medium storing code executable to adapt at least one computer system to perform a portion of a process to fabricate at least part of the IC package of claim 1.

17. A method comprising:
providing an integrated circuit (IC) package comprising a set of stacked memory layers comprising memory cell circuitry, and comprising a set of one or more logic layers electrically coupled to the set of stacked memory layers, the set of one or more logic layers comprising a helper processor coupled to the memory cell circuitry of the set of one or more stacked memory layers and comprising a memory interface coupled to the helper processor and coupled to a processor device external to the IC package;
operating the memory interface to perform memory accesses for at least the external processor device; and
accessing and executing instructions at the helper processor to perform at least one task on behalf of at least the external processor device.

18. The method of claim 17, further comprising:
operating the memory interface to perform a memory access for the helper processor device.

19. The method of claim 17, wherein accessing the instructions comprises accessing the instructions from at least one of: a non-volatile memory of the IC package; and the memory cell circuitry.

20. The method of claim 19, further comprising:
receiving, at the IC package, at least a portion of the instructions from the external processor device; and
storing the at least a portion of the instructions at the memory cell circuitry.

21. The method of claim 17, wherein:
the external processor device signals a request for an operation on a data structure stored in the memory cell circuitry;
accessing and executing instructions at the helper processor to perform the at least one task comprises accessing and executing instructions at the helper processor to perform the operation on the data structure stored in the memory cell circuitry; and
the method further comprises providing a result of the operation for output to the external processor device.

22. The method of claim 17, wherein:
accessing and executing instructions at the helper processor to perform the at least one task comprises accessing and executing instructions at the helper processor to perform an interrupt handling routine in response to an interrupt.

23. The method of claim 17, wherein accessing and executing instructions at the helper processor to perform the at least one task comprises accessing and executing instructions at the helper processor to execute at least one thread.

24. The system of claim 23, wherein the at least one thread includes at least one of: a background operating system task; a security scan task; a virus scan task; a defragmentation task; a garbage collection task; and a hypervisor task.

25. The method of claim 17, wherein:
the external processor device comprises a first external processor device; and
accessing and executing instructions at the helper processor to perform the at least one task comprises accessing and executing instructions at the helper processor to store at the memory cell circuitry a value representing a result of a computation performed by a second external processor device and to access the value from the memory cell circuitry and output the value to the first external processor device in response to a request from the first external processor device for the result of the computation from the second external processor device.

26. The method of claim 17, wherein
the external processor device comprises a first external processor device; and
accessing and executing instructions at the helper processor to perform the at least one task comprises accessing and executing instructions at the helper processor to recalculate a result of a computation performed by a second external processor device by accessing data used in the computation from the memory cell circuitry, to perform the computation using the accessed data, and to output the result of the performed computation to a second external processor device in response to a request from the first second external processor device for the result of the computation from the second external processor.

27. A method comprising:
in response to a request from a processor device external to an integrated circuit (IC), executing instructions at a helper processor of the IC, the instructions including instructions to perform one or more data accesses to a stacked memory in communication with the helper processor.

28. The method of claim 27, further comprising:
providing a result from execution of the instructions from the IC to the external processor device.

29. The method of claim 27, further comprising:
accessing, in preparation for execution, the instructions from at least one of: the stacked memory; and a non-volatile memory.

30. The method of claim 27, wherein:
the request includes a thread identifier; and
executing the instructions at the helper processor comprises executing the thread at the helper processor in response to the thread identifier.

31. A method comprising:
executing instructions at helper processor of an integrated circuit (IC) package to perform an operation on a data structure stored in stacked memory of the IC package in response to a request from a processor device external to the IC package.

32. The method of claim 31, further comprising:
providing a result of the operation from the IC package to the processor device.

33. The method of claim 31, further comprising:
accessing, in preparation for execution, the instructions from at least one of: the stacked memory; and a non-volatile memory of the IC package.

34. The method of claim 31, wherein the operation comprises at least one of: a search operation; an insert operation; a modify operation; a delete operation; a sort operation; a find maximum operation; a find minimum operation; a find average, median, or mode operation; a filtering operation; a matrix operations; a table join operation; a MapReduce operation; a fast Fourier transforms (FFTs) operation; a graphic rendering operation; and an audio processing operation.

35. An integrated circuit (IC) comprising:
a set of one or more logic layers electrically coupleable to a set of stacked memory layers implementing memory cell circuitry and electrically coupleable to a processor device external to the set of one or more logic layers, the set of one or more logic layers comprising a helper processor to execute instructions that utilize data stored in the memory cell circuitry on behalf of the external processor device.

36. The IC of claim 35, wherein the helper processor is to execute instructions stored in the memory cell circuitry.

37. The IC of claim 35, wherein the set of one or more logic layers further comprises:
a memory interface coupled to the helper processor and coupleable to the processor device, the memory interface to perform memory accesses for the external processor device and to perform memory accesses for the helper processor
